(19) United States
(12) Patent Application Publication
(10) Pub. No.: US 2019/0054606 A1
(43) Pub. Date: Feb. 21, 2019

(54) STAPLER

(71) Applicant: APEX MFG. CO., LTD., Taichung City (TW)

(72) Inventor: Chih-Wei HU, Taichung City (TW)

(21) Appl. No.: 15/680,677

(22) Filed: Aug. 18, 2017

(51) Int. Cl. B25C 5/02; B25C 5/16

(52) U.S. Cl. CPC B25C 5/0285; B25C 5/1658; B25C 5/1606

(57) ABSTRACT

The stapler includes a main body, a magazine, a striker, and a driving portion. The main body encloses a receiving space and has an opening at a lower portion of a front end thereof A longitudinal direction is defined by the front end and a rear end of the main body. The magazine is arranged in the main body to receive staples. The striker is arranged at the front end of the main body and is movable linearly above the opening of the main body. The driving portion is arranged in the main body and is connected to the striker. The driving portion drives the striker to move downward to strike a staple out. The striker has a bottom end which is recessed and has two ends and an intermediate portion between the two ends. The intermediate portion is more recessed than the two ends.

### BACKGROUND OF THE INVENTION

### Field of the Invention

The present invention relates to a stapler.

### Description of the Prior Art

A conventional stapler includes a main body, a magazine, a striker, and a driving portion, such as a pressing arm or a trigger. The magazine is received in the main body for receiving nails. The striker is located at a front end of the main body and is linearly movable along a vertical direction. The driving portion is engaged with the striker to drive the striker to move downward to strike nails out.

The conventional magazine has an elastic element to push the nails frontward, but the elasticity can not be too strong to result the failure of striking. However, it also results that the first nail lacks of enough elastic force so they the lower end of the nail tends to move backward when the nail is hit by the striker. Thus, the nail may be inclined so that it becomes difficult to strike the nail out successfully. Therefore, the efficiency of working is reduced, and the nails and the components of the stapler may be abraded.

### SUMMARY OF THE INVENTION

The main object of the present invention is to provide a stapler which reduces failures of striking.

To achieve the above and other objects, a stapler of the present invention includes a main body, a magazine, a striker, and a driving portion.

The main body encloses a receiving space and has an opening at a lower portion of a front end thereof The receiving space communicates the opening. A longitudinal direction is defined by the front end and a rear end of the main body. The magazine is arranged in the main body to receive staples. The striker is arranged at the front end of the main body and is movable linearly above the opening of the main body. The driving portion is arranged in the main body and is connected to the striker. The driving portion drives the striker to move downward to strike a staple out. The striker has a bottom end which is recessed. The bottom end has two ends and an intermediate portion between the two ends. The intermediate portion is more recessed than the two ends.

Thereby, the staple can retain erected and is pushed smoothly. In addition, the staples can be separated better for striking only one of the staples.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a partial stereogram of the present invention;

FIG. 2 is an illustration of the present invention;

FIG. 3 is a profile of the present invention when a staple has not been struck out;

FIG. 3A is a partial enlargement of FIG. 3;

FIG. 4 is a profile of the present invention when a staple is struck out;

FIG. 4A is a partial enlargement of FIG. 4;

FIG. 5 is a partial cross-section drawing of the present invention;

FIG. 6 is a profile showing a striker of a second embodiment of the present invention;

FIG. 7 is a profile showing a striker of a third embodiment of the present invention.

### DETAILED DESCRIPTION OF THE PREFERRED EMBODIMENTS

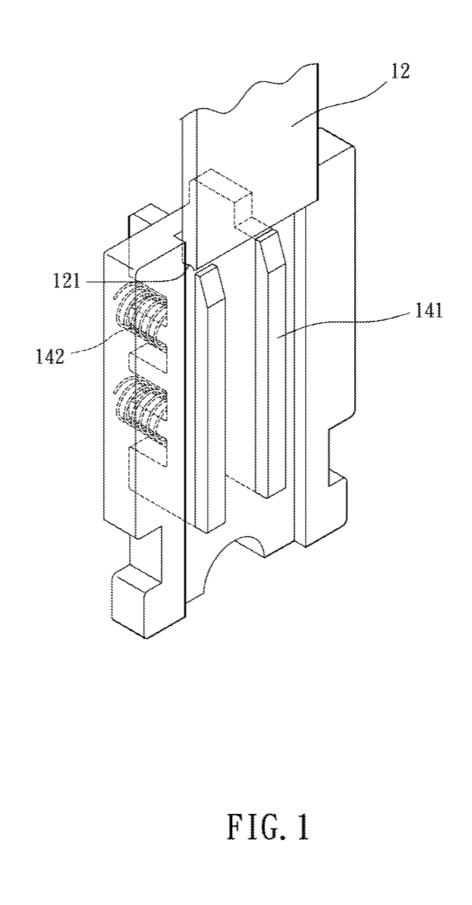

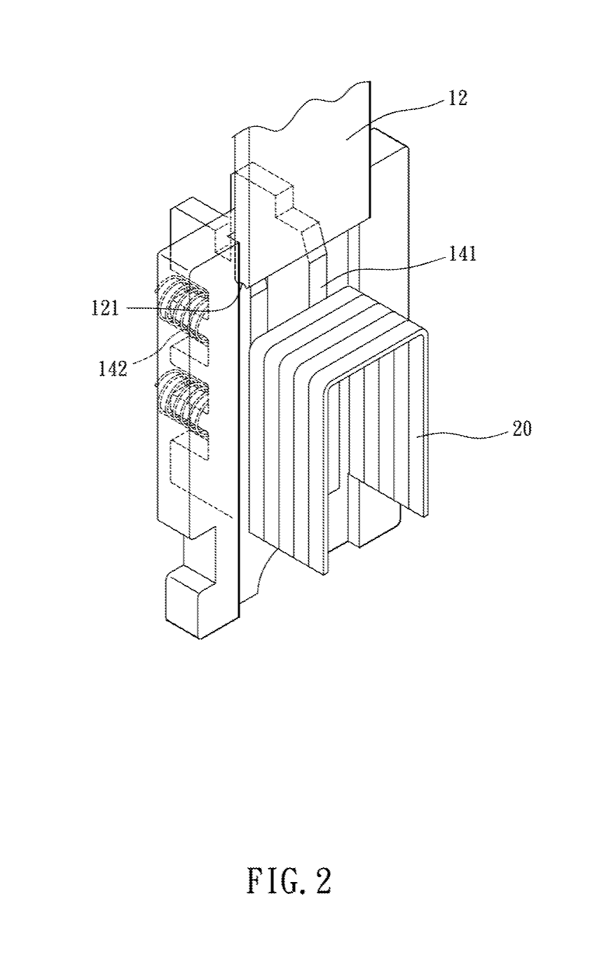

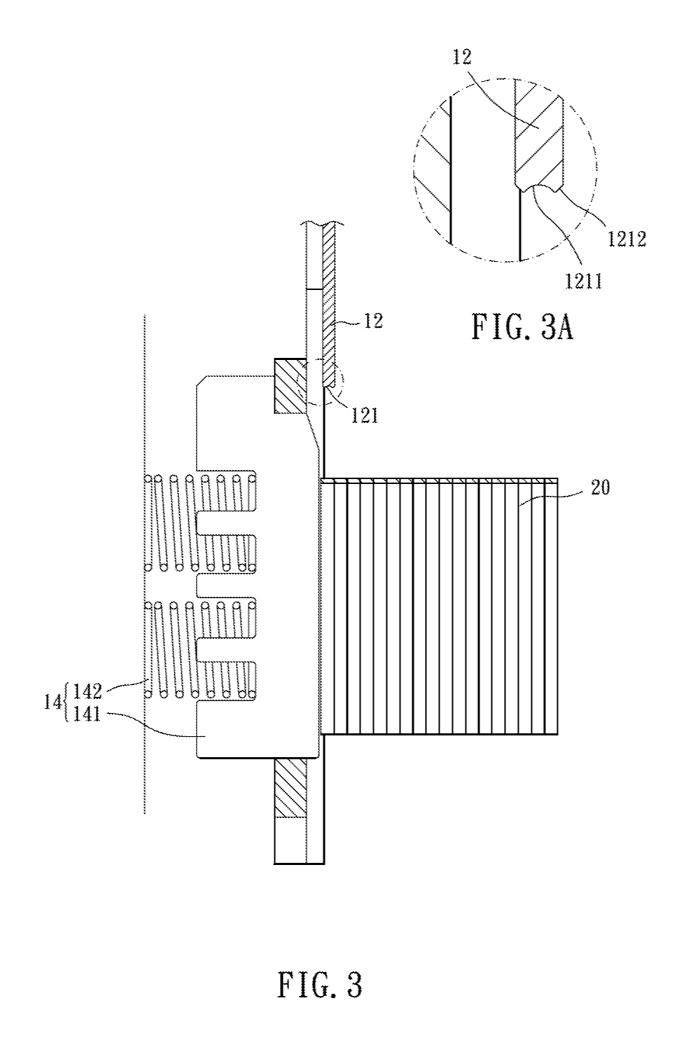

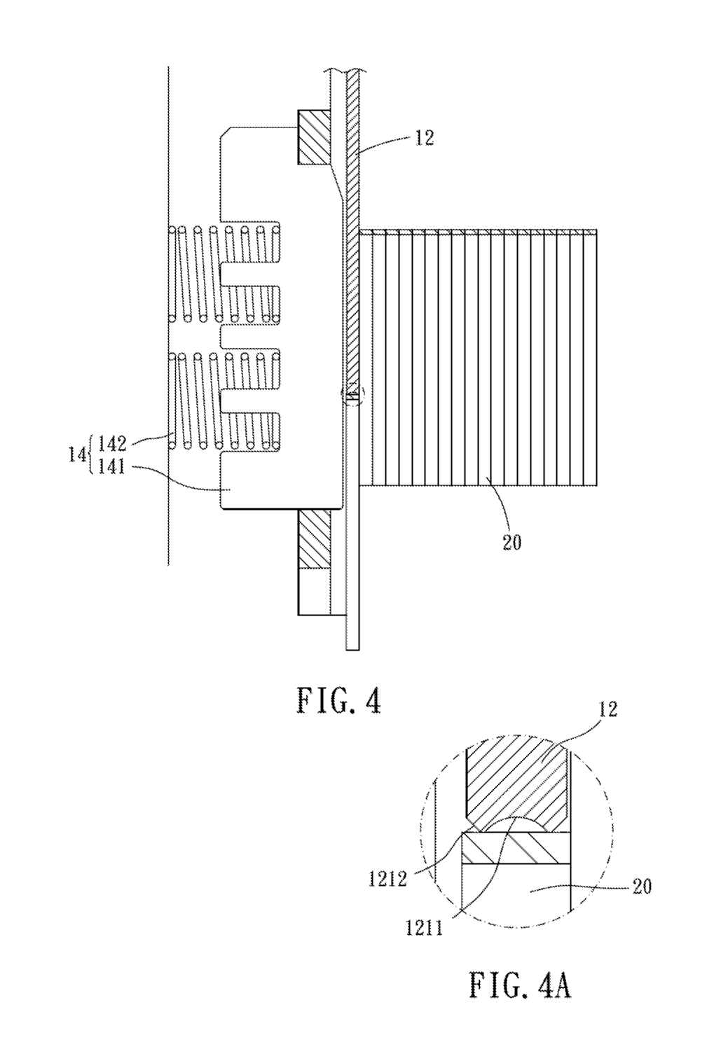

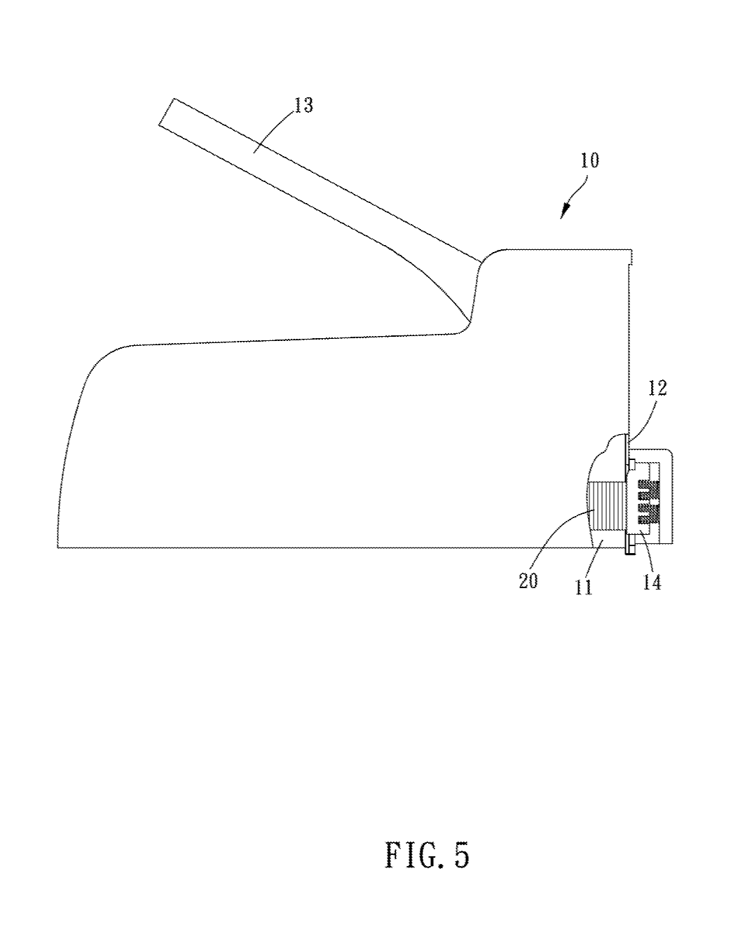

Please refer to FIG. 1 to FIG. 5, the stapler of the present invention includes a main body 1, a magazine 11, a striker 12, 12a, 12b, and a driving portion.

The main body 10 encloses a receiving space and has an opening at a lower portion of a front end thereof The receiving space communicates the opening. A longitudinal direction is defined by the front end and a rear end of the main body 10. The magazine 11 is arranged in the main body 10 to receive staples 20. The striker 12, 12a, 12b is arranged at the front end of the main body 10 and is movable linearly above the opening of the main body 10. The driving portion is arranged in the main body 10 and is connected to the striker 12, 12a, 12b. The driving portion drives the striker 12, 12a, 12b to move downward to strike a staple 20 out. The striker 12, 12a, 12b has a bottom end 121 which is recessed. The bottom end 121 has two ends and an intermediate portion between the two ends. The intermediate portion is more recessed than the two ends. A line defined by the two ends of the bottom end 121 is parallel to the longitudinal direction.

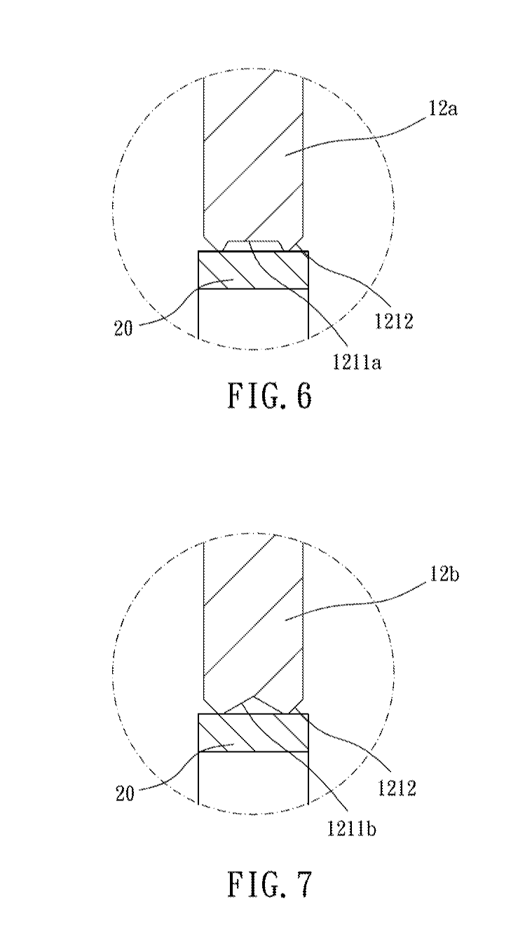

Specifically, the bottom end 121 of the striker 12, 12a, 12b is formed with a groove 1211, 1211a, 1211b. In the present embodiment, the groove 1211 has a cross-section shaped as a circular segment. In other embodiments, as shown in FIG. 6, the groove 1211a has a cross-section shaped as a trapezoid, and a width of a bottom of the groove 1211a is smaller than a width of an opening of the groove 1211a. In FIG. 7, the groove 1211b has a triangle cross-section, and a width of the groove 1211b is increasing from a bottom thereof toward an opening thereof More specifically, a maximum depth of the groove 1211, 1211a, 1211b is 0.1-1 time a thickness of the striker 12, 12a, 12b along the longitudinal direction. Preferably, the maximum depth of the groove 1211, 1211a, 1211b is 0.25-0.5 time a thickness of the striker 12, 12a, 12b along the longitudinal direction.

More preferably, two inclined guiding faces 1212 are formed at two sides of the groove 1211, 1211a, 1211b. Each inclined guiding face 1212 faces opposite to the groove 1211, 1211a, 1211b. The inclined guiding faces 1212 can help separate the staples.

In the present embodiment, the stapler further includes a stopping structure 14. The stopping structure 14 includes an elastic element 142 and a stopping element 141. The stopping element 141 is located in front of the magazine 11 and the striker 12. The elastic element 142 is biased between the stopping element 141 and the front end of the main body 10 so that the stopping element 141 tends to move toward the magazine 11. The stopping structure 14 is adapted for fitting staples in various sizes.

Thereby, if the staple has a small thickness, the striker can push the staple by the inner wall of the groove. Thus, the staple can be pushed out vertically. Besides, the inclined guiding faces can help separate the staples to strike only one staple out. In addition, the striker of the present invention is easy to manufacture, and the weight may not increase.

What is claimed is:

1. A stapler including:
a main body, enclosing a receiving space and having an opening at a lower portion of a front end thereof, the receiving space communicating the opening, a longitudinal direction being defined by the front end and a rear end of the main body;
a magazine, arranged in the main body to receive staples;
a striker, arranged at the front end of the main body and being movable linearly above the opening of the main body;
a driving portion, arranged in the main body and connected to the striker, the driving portion driving the striker to move downward to strike a staple out;
wherein the striker has a bottom end which is recessed, the bottom end has two ends and an intermediate portion between the two ends, the intermediate portion is more recessed than the two ends.

2. The stapler of claim 1, wherein a line defined by the two ends of the bottom end is parallel to the longitudinal direction.

3. The stapler of claim 1, wherein a groove is formed on the bottom end of the striker, the groove has a cross-section shaped as a circular segment.

4. The stapler of claim 1, wherein a groove is formed on the bottom end of the striker, the groove has a cross-section shaped as a trapezoid, a width of a bottom of the groove is smaller than a width of an opening of the groove.

5. The stapler of claim 1, wherein a groove is formed on the bottom end of the striker, the groove has a triangle cross-section, a width of the groove is increasing from a bottom thereof toward an opening thereof

6. The stapler of claim 1, further including a pressing grip above the main body.

7. The stapler of claim 1, further including a stopping structure, the stopping structure including an elastic element and a stopping element, the stopping element being located in front of the magazine and the striker, the elastic element being biased between the stopping element and the front end of the main body so that the stopping element tends to move toward the magazine, the stopping structure being adapted for fitting staples in various sizes.

8. The stapler of claim 3, wherein a maximum depth of the groove is 0.1-1 time a thickness of the striker along the longitudinal direction.

9. The stapler of claim 8, wherein the maximum depth of the groove is 0.25-0.5 time the thickness of the striker along the longitudinal direction.

10. The stapler of claim 4, wherein a maximum depth of the groove is 0.1-1 time a thickness of the striker along the longitudinal direction.

11. The stapler of claim 10, wherein the maximum depth of the groove is 0.25-0.5 time the thickness of the striker along the longitudinal direction.

12. The stapler of claim 5, wherein a maximum depth of the groove is 0.1-1 time a thickness of the striker along the longitudinal direction.

13. The stapler of claim 12, wherein the maximum depth of the groove is 0.25-0.5 time the thickness of the striker along the longitudinal direction.

14. The stapler of claim 3, wherein two inclined guiding faces are formed at two sides of the groove, each inclined guiding face faces opposite to the groove.

15. The stapler of claim 4, wherein two inclined guiding faces are formed at two sides of the groove, each inclined guiding face faces opposite to the groove.

16. The stapler of claim 5, wherein two inclined guiding faces are formed at two sides of the groove, each inclined guiding face faces opposite to the groove.
